(19) United States
(12) Patent Application Publication
(10) Pub. No.: US 2004/0221034 A1
(43) Pub. Date: Nov. 4, 2004

(54) Centralized measurement of web performance

(76) Inventors: Balas Natarajan Kausik, Los Gatos, CA (US); Janardhanan Jawahar, San Jose, CA (US)

Correspondence Address: PATENT DEPARTMENT, SKADDEN, ARPS, SLATE, MEAGHER & FLOM LLP, FOUR TIMES SQUARE, NEW YORK, NY, 10036, US

(21) Appl. No.: 10/739,681

(22) Filed: Dec. 17, 2003

Related U.S. Application Data
(60) Provisional application No. 60/434,686, filed on Dec. 18, 2002.

(51) Int. Cl. G06F 15/173; G06F 15/16

(52) U.S. Cl. 709/224; 709/203

(57) ABSTRACT

A proxy server is deployed between the user and a content server accessed by an application being accessed by the user. The proxy server intercepts a user's request for content, logs the time the request was received, and forwards the request to the content server. When the content server responds to the request with a document, the proxy server intercepts the document, modifies the document by inserting one or more time-reporting script(s), and forwards the modified document to the user's browser for rendering. At the browser, the script sends a report back to the proxy server when rendering is completed. The elapsed time between when the proxy server first receives the request for content, and when the proxy server receives a “rendering complete” report, is a measure of the responsiveness of the application.

This patent claims the benefit of U.S. provisional patent application No. 60/434,686 filed on Dec. 18, 2002.

### FIELD

This patent relates generally to measuring response time in a networked environment. More specifically, this patent relates to measuring the time elapsed between a user's request for and receipt of a web document, using a proxy server installed at a point on the network between the user and a content server.

### BACKGROUND

It is commonly required to measure the performance of web applications, with respect to their response time to requests from users. The predominant method for carrying out such measurements is to synthesize a sequence of requests from automated agents situated at a variety of remote locations. These agents then report their respective response times to a centralized database for analysis. This method is cumbersome in that it requires the maintenance of many remote agents. It is also inaccurate in that it measures synthesized transactions rather than actual user responses.

Another method both centralizes the measuring agent, and measures actual user responses. For example, available commercial technologies such as Packeteer's AppVantage or NetQos's SuperAgent measure the transmission time of individual web objects. However, these measurements are not indicative of actual performance provided to the user, since the user typically requests a web document that is a composite of many web objects. While it is possible to deduce the response time for composite documents from the delivery times for the individual objects comprising the composite, such deduction is difficult to automate and is often inaccurate.

Hewlett Packard's Openview Web Transaction Observer uses yet another method to measure the response time of a web application. This system requires a modification to the content server to allow the content server to respond with a dummy container page containing a sub-frame. The document actually requested is loaded in both the contained page and the sub-frame. More specifically, the requested document is first loaded into the user's web browser, and is then recursively requested to be reloaded again. This type of double loading has several undesirable side effects. For example, if the original request by the user was to subtract $500 from his bank account in an online banking session, that request is now repeated by the dummy container page. The result is that $1000 is deducted from the user's account. Another unfortunate side effect is that the original document requested by the user may include scripting that refers to the “parent” frame, i.e., the highest level container in the document. This reference would now point to the dummy container and not to the original container, thereby resulting in incorrect rendering of the content.

### SUMMARY

We disclose a system for measuring the responsiveness of web applications as experienced by users in networked transactions. A proxy server is deployed between the user and a content server accessed by the application. The proxy server intercepts a user's request for content, logs the time the request was received, and forwards the request to the content server. The proxy server subsequently intercepts the response (i.e., the web page or other document containing the requested content) from the content server, and modifies the document by inserting one or more time-reporting logic code (e.g., script(s)). The proxy server then forwards the modified document to the user's browser for rendering. At the browser, the script(s) send a report back to the proxy server when rendering is completed. The elapsed time between when the proxy server first receives the request for content, and when the proxy server receives a “rendering complete” report, is a measure of the responsiveness of the application.

Various embodiments of the above-mentioned technique may display some or all of the following advantages over the background art: (a) remote agents can be eliminated as desired; (b) measurements can be made of actual user experiences, not merely of synthetic transactions; (c) no modifications to the content server, the content or to the user's browser are required; and/or (d) the proxy server can be implemented transparently at a point in the network between the user and the content server.

### BRIEF DESCRIPTION OF THE FIGURES

FIG. 1 illustrates an exemplary operating environment and performance measurement system.

FIG. 2 illustrates certain exemplary processes implemented by the proxy server, including intercepting a user's request for content, opening a performance log, and forwarding that the user's request to the content server.

FIG. 3 illustrates additional exemplary processes implemented by the proxy server, including intercepting a content server's response to a user's request for content, adding performance-monitoring scripts, forwarding the response to the user's browser, and receiving confirmation of rendering from the browser.

FIG. 4 illustrates the overall timeline of events in an exemplary performance-measuring process.

FIG. 5 illustrates an exemplary performance-measuring script that may be used by the proxy server.

### DETAILED DESCRIPTION

U.S. provisional patent application No. 60/434,686, filed on Dec. 18, 2002, is hereby incorporated by reference in its entirety.

1. Exemplary Operating Environment & Performance Measurement System

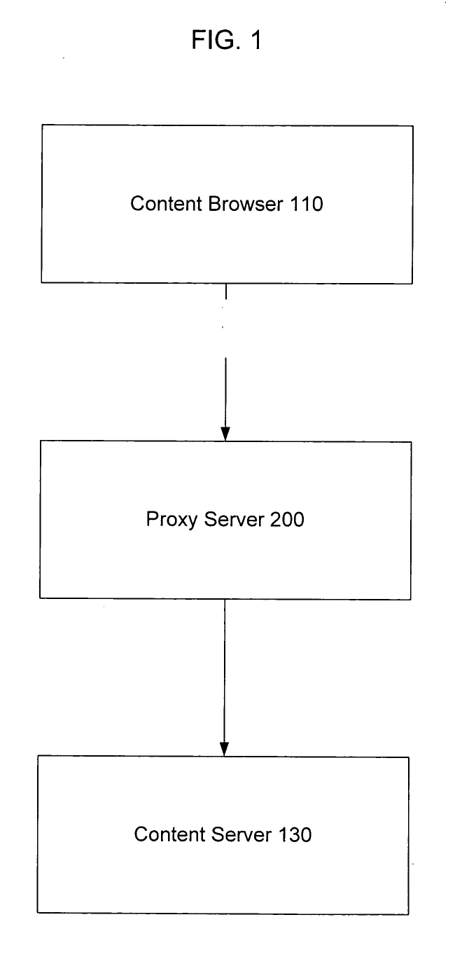

FIG. 1 illustrates an exemplary operating environment including a user browser 110 connected over a network 120 to, and accessing content from, a content server 130. In an exemplary performance measurement system, the techniques disclosed herein are implemented using a transparent proxy server 200 located on the network 120 in front of the content server 130. When the user 110 requests content from the content server 130, the request is first intercepted by the proxy server 200, processed at the proxy server, and then sent to the content server 130. The content server 130 provides a response, which is processed by proxy server 200 and then returned to the user 110.

Technologies for implementing proxy servers are well known in the art, and need not be described in detail herein. For example, a proxy server could be implemented using a general purpose computer, including a processor, fixed or removable memory (or other form of computer-readable medium), I/O interfaces, with software implementing the exemplary proxy server processes disclosed in the following section.

2. Exemplary Proxy Server Processes

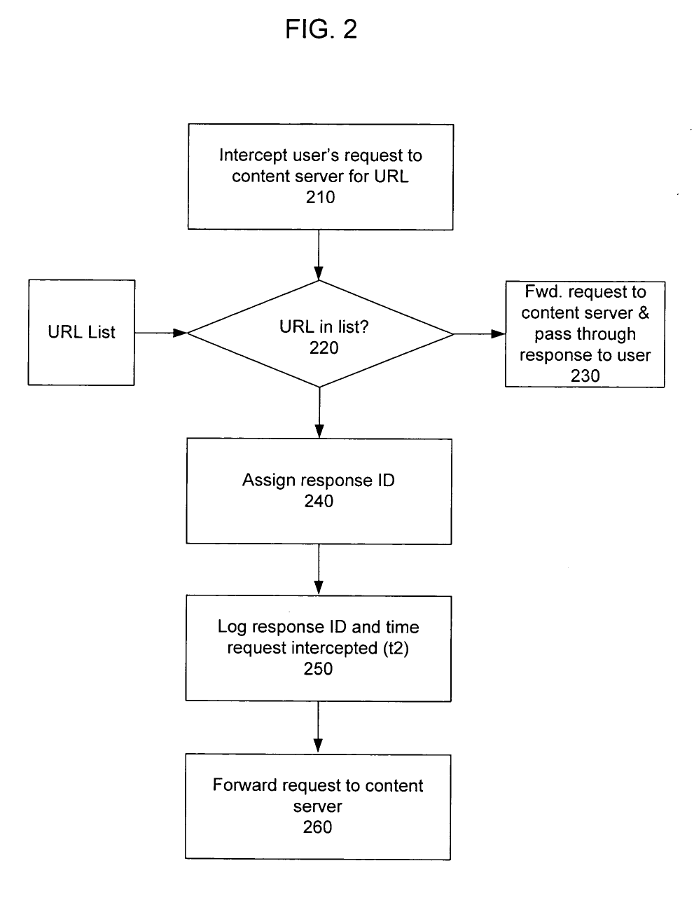

FIG. 2 illustrates certain exemplary processes implemented by the proxy server, for intercepting a user's request for content and forwarding the user's request to the content server.

At step 210, the proxy server intercepts the user's request to the content server for a URL. For later reference, the time at which the request is issued by the user's browser will be referred to as time t1, and the time at which the user's request is received at the proxy server will be referred to as t2.

At step 220, the proxy server determines if the URL (or document at that URL) is one for which performance is to be measured. In one exemplary implementation, those items subject to performance measurement are maintained in a database or list (e.g., previously specified by a system administrator) that can be consulted by the proxy server.

At step 230, if the URL is not on the list, the proxy server simply forwards the request to the content server, awaits a response, and passes the response back to the user.

At step 240, if the URL is on the list, the proxy server assigns a unique identifier that will be used to identify the response to the request. The identifier may take any desired format in accordance with a particular implementation, including without limitation, a number, a string (perhaps simply the URL itself), or any combination thereof.

At step 250, the proxy server logs the response identifier, as well as the time (t2) at which the request was received at the proxy server. This time can be determined by reference to a clock within, or external to, the proxy server.

At step 260, the proxy server forwards the request to the content server.

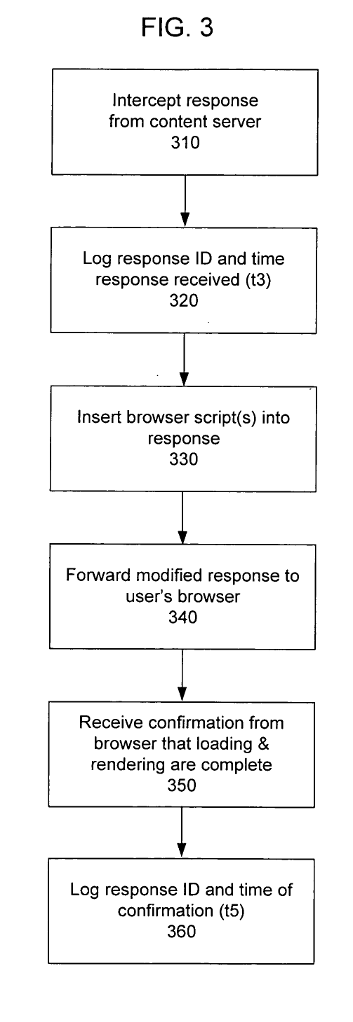

FIG. 3 illustrates additional exemplary processes implemented by the proxy server, including intercepting a content server's response to a user's request for content, adding performance-monitoring scripts, forwarding the response to the user's browser, and receiving confirmation of rendering from the browser.

At step 310, the proxy server intercepts the response sent from the content server back to the browser.

At step 320, the proxy server logs the response identifier, as well as the time (t3) at which the response was intercepted at the proxy server. This time can be determined by reference to a clock within, or external to, the proxy server.

At step 330, the proxy server adds performance-monitoring browser script into the document or object embodying the response.

At step 340, the proxy server forwards the modified response to the browser. The browser executes the response, including loading and rendering the content and executing the script. When executed by the browser, the script creates and sends a message back to the proxy server, carrying the response identifier and a confirmation that the request is now complete.

At step 350, the proxy server receives the confirmation that loading and rendering is complete.

At step 360, the proxy server makes another entry in the log against the response identifier, including the time (t5) at which the confirmation was received at the proxy server.

3. Responsiveness Measurements

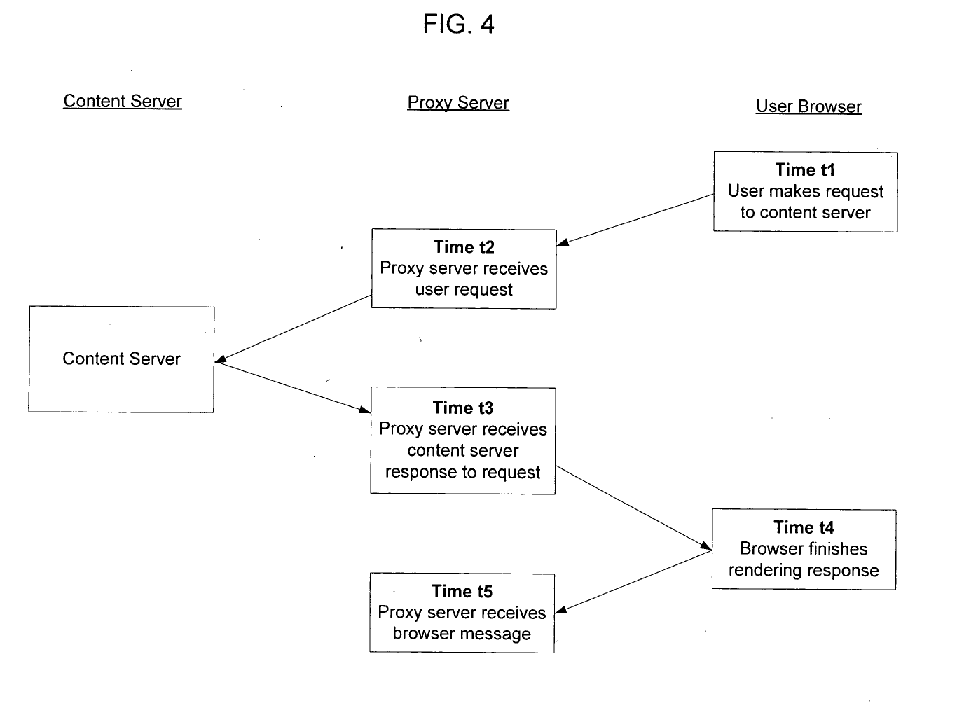

FIG. 4 illustrates the overall timeline of events in an exemplary performance-measuring process.

At time t1, the user requests a web document at the user's browser.

However, unless the proxy server is at the same computer as the user's browser, the request does not reach the proxy server until time t2. This time, t2, is logged at the proxy server as the as the interception-of-request time.

The proxy server forwards the request to the content server. At time t3, the proxy server receives the content server's response. This time, t3, is logged at the proxy server.

The proxy server then modifies the response by adding performance-measuring scripts, and forwards the modified response to the user's browser.

At time t4, the browser completes loading and rendering the response, and the script sends a confirmation to that effect back to the proxy server.

The confirmation, however, does not reach the proxy server until time t5. This time, t5, is logged at the proxy server as the confirmation-of-rendering-completion time.

The difference between the confirmation-of-rendering-completion time, t5, and the interception-of-request time, t2, is a measure of the performance for this request as determined by the proxy server. This time difference and can be logged and/or reported to the appropriate parties.

However, from the user's perspective, the actual performance time is the difference between the completion-of-loading-and-rendering-time, t4, and the initiation-of-request time, t1. What is the relationship between the proxy server-determined responsiveness time, (t5-t2), and the user-experienced, actual responsiveness time (t4-t1)?

It is clear that

t5−t2=(t4−t1)+(t5−t4)−(t2−t1).

Taking the statistically expected values on both sides of the equation gives

EXP(t5−t2)=EXP(t4−t1)+EXP(t5−t4)−EXP(t2−t1).

Typically, the user's request will be small in terms of the number of bytes and will fit in a single TCP/IP packet. As long as the reporting message is designed to be small enough to also fit in a single packet (or, more generally, to occupy the same number of packets as the requesting message), then the lag in requesting and reporting times will be comparable. Therefore,

EXP(t5−t4)=EXP(t2−t1)},

so that:

EXP(t5−t2)=EXP(t4−t1).

In other words, on average, the value of the measured quantity (t5-t2) will be the same as the value of the actual quantity (t4-t1).

4. Additional Performance Indicators

In addition to just the overall loading time (t4-t1), other times (or time differences) can be used as additional performance indicators.

For example, let t3′ indicate when the browser actually starts loading the response. Then, (t3′-t3) indicates how much time is elapsed between when the proxy server receives the response from the content server (t3) and when the browser starts loading the response (t3′). That is, (t3′-t3) is a measure of the latency of the network.

In addition, many documents contains both HTML as well as embedded objects, which will be loaded at different times. Typically, the HTML is loaded first (say, at time t3″) and the embedded objects are loaded (with completion of rendering at t4). Therefore, (t3′-t3″) is a measure of the time required to load the HTML, and (t4-t3″) is a measure of the time required to load the embedded objects.

Another metric, (t4-t3′) indicates how much time elapsed between when the browser starts loading the response (t3′) and when the browser finishes rendering the response (t4). Therefore, (t4-t3′) is a measure of the overall browser speed.

5. Exemplary Scripts

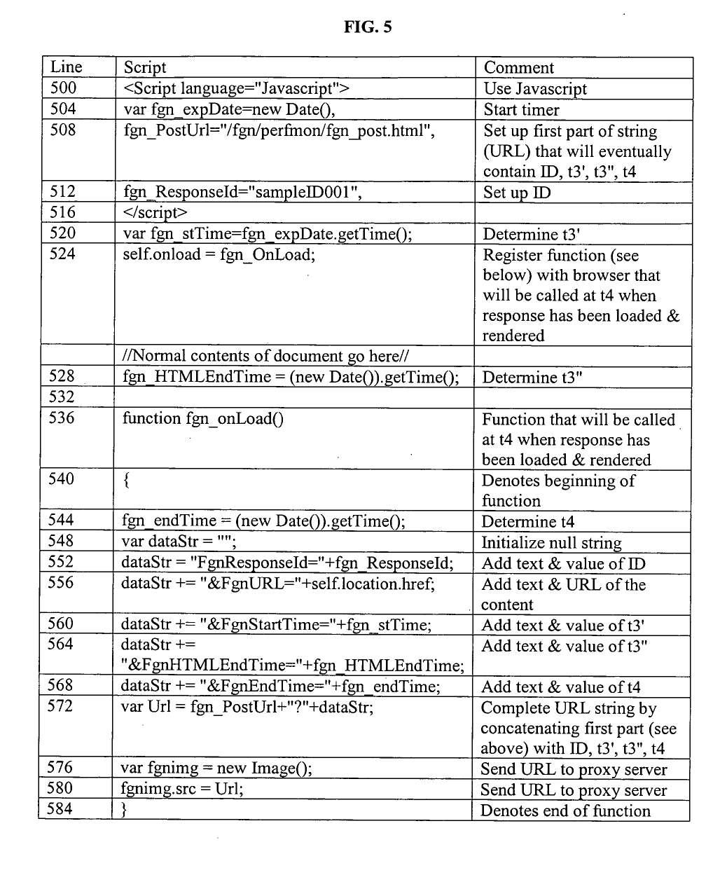

FIG. 5 shows an exemplary script inserted into the response by an exemplary implementation of the proxy server, before forwarding the response to the browser. This script, when executed by the browser during loading of the response, allows the determination of times t3′, t3″ and t4 set forth above, and the return of those data to the proxy server. The exemplary script of FIG. 5 is configured to use Javascript running on Microsoft's Internet Explorer browser. Those skilled in the art will readily appreciate how to adapt the script to other forms of logic code supported by the browser, including the VBScript scripting language, Java applets, Active/X objects, and/or still other forms of logic code.

At line 500, the script identifies that it uses Javascript.

At line 504, the script starts a timer that will be used to determine the various times described below.

At line 508, the script sets up the first part of a URL that will eventually contain the response ID, and times t3′, t3″, t4. This part of the URL specifies an address of the URL in the file directory of the proxy server (in this example, /fgn/perfmon/fgn_post.html).

At line 512, the script establishes a response ID (in this example, “SampleID001”) for tracking purposes.

At line 520, at the beginning of the loading process, the script reads the browser computer's clock to determine t3′—the start of document loading.

At line 524, the script specifies to the browser a custom function (fgn OnLoad) that will be called by the browser (later at time t4) when the response has been completely loaded and rendered. Details of this function will be described with respect to lines 536 to 584 below.

The contents of the response document would, in this embodiment, occur between lines 524 and 528. That is, the portions of the script above line 524 are added at the top of the response document, and the portions of the script below line 524 are added below.

Thus, the timer is started, and the begin load time t3′ is determined, followed by loading. In an exemplary embodiment, the document to be loaded could include both HTML and embedded objects.

At line 528, at the conclusion of the HTML loading, the script reads the browser computer's clock to determine t3″—the end of HTML loading (but with embedded object loading still to be performed).

The remainder of the script, lines 536 to 584, set forth the details of the function fgn_on Load that is automatically called (at time t4) by the browser after all the embedded objects have been loaded, and the entire document has been rendered.

At lines 536 & 540, the function fgn_on Load( ) is defined.

At line 544, the script reads the browser's clock to determine t4— the completion of loading and rendering.

Lines 548-572 involve creating the string that will represent an URL containing the timing results.

At line 548, a data string (dataStr) is initialized.

At line 552, the data string is concatenated with the text and value of the response ID. For example, at the end of this step, the string might contain the text: “FgnResponseld=SampleID001”.

At line 556, the data string is concatenated with the text and value of the document URL. For example, at the end of this step, the string might contain the text: “FgnResponseld=SampleID001&FgnURL=http://www.fineground.com/SampleURL”.

At line 560, the data string is concatenated with the text and value of the start of the loading time t3′. As is conventional, the time would typically be expressed as the number of seconds elapsed since some absolute reference. For example, if the reference is midnight, Jan. 1, 1970 and if t3′=midnight on Jan. 1, 2003 (i.e., 33 years to the day since Jan. 1, 1970), then t3′ would be 33×365×24×60×60=1040688000 seconds (ignoring leap seconds, leap years, etc. for the purposes of simplifying this example). In this example, at the end of this step, the string might contain the text: “FgesponseId=SampleID001&FgnURL=www.fineground.com/SampleURL&FgnStart Time=1040688000.”

At line 564, the data string is concatenated with the text and value of the end of the HTML (but not embedded object) loading time. For example, if HTML loading took 5 seconds, then at the end of this step, the string might contain the text: “FgnResponseld=SampleID001&FgnURL=www.fineground.com/SampleURL&FgnStart Time=1040688000&FgnHTMLEndTime=1040688005”.

At line 568, the data string is concatenated with the text and value of the end of the total (i.e., HTML and embedded object) loading time. For example, if object loading took another 10 seconds, then at the end of this step, the string might contain the text: “FgnResponseld=SampleID001&FgnURL=www.fineground.com/SampleURL&FgnStart Time=1040688000&FgnHTMLEndTime=1040688005&FgnEndTime=1040688015”.

At line 572, the address of the URL (from line 508) and the data string (from line 568) are concatenated to form the URL. For example, the URL might contain the text: “http://name.of.proxy.server/fgn/perfnon/fgn_post.html?FgnResponseId=SampleID001&FgnURL=www.fineground.com/SampleURL&FgnStartTime=1040688000&FgnHTM LEndTime=1040688005&FgnEndTime=1040688015”.

At this point, the completed URL is passed back to the proxy server, which extracts t3′, t3″ & t4, and logs them against the response ID. The proxy server can then compute performance metrics such as t4-t3′, t4-t3″, and t4-t1 as described above.

6. Alternate Embodiments and Aspects

In the exemplary embodiment of FIG. 2, a list of URLs was checked to determine those for which responsiveness would be measured. In an alternate embodiment, the proxy server could measure randomly a sample of the requests that fall within the URL list, or could randomly sample the requested URLs without reference to a list. In yet another embodiment, the proxy server could be connected to a network switch that may randomly split requests between the proxy server and direct to the content server.

### 7. CONCLUSION

As a matter of convenience, the techniques of this patent have been disclosed in the exemplary context of a web-based system in which the user accesses visual content identified by URLs from a browser that loads and renders the content. However, those skilled in the art will readily appreciate that other user access devices, and content identifiers, may also be used.

For example, instead of URLs, content may be identified via other known means. More generally, the techniques disclosed herein can be used to measure performance associated with the playback of audio files, the execution of computer codes, and/or any other process that can be performed using a computer over a network. Thus, the term content should be interpreted broadly to include any kind of information accessible over a network, which might include both traditional forms of content such as data or other non-functional information, as well as functional information such as computer code.

Similarly, it should be appreciated that the proposed techniques will operate on any networked computer, including without limitation, wireless networks, handheld devices, and personal computers. Therefore, exemplary terms such as web, browser, URL and the like should be interpreted broadly to include currently and hereafter known substitutes and other equivalents, counterparts, and extensions thereof.

What is claimed is:

1. A method for characterizing the performance over a network to a request for information, comprising:
(a) at a proxy server between a user and a server, intercepting a request for information;
(b) forwarding said request to a server to which said request was addressed;
(c) intercepting a response from said server;
(d) adding performance-measuring logic code to said response;
(e) forwarding said response to said user's browser;
(f) receiving confirmation from said browser of execution of said request;
(g) determining, as a performance metric, the elapsed time between said interception of said request and said receipt of confirmation, by using timing information received from execution of said logic code at said browser.

2. The method of claim 1 further comprising
(i) after said (a), logging a time at which said request was intercepted at said proxy server, and
(ii) after said (f), logging a time at which said confirmation was received at said proxy server;
and where
(iii) said elapsed time in said (g) is the difference between said times in said (i) and (ii).

3. The method of claim 1 further comprising, before at least said (c), of determining whether said request is one for which performance is to be characterized.

4. The method of claim 1 further comprising assigning a unique identifier to be used in connection with said logging.

5. The method of claim 1 further comprising, after at least said (c), of logging a time at which said response is received at said proxy server.

6. The method of claim 1 where said logic code includes Javascript.

7. The method of claim 1 further comprising computing an additional performance metric based on the loading of a portion of said response at said browser.

8. The method of claim 7 where said additional performance metric represents the elapsed time required to load HTML code within said response.

9. The method of claim 7 where said additional performance metric represents the elapsed time required to load embedded objects within said response.

10. The method of claim 7 where said additional performance metric represents the overall browser responsiveness.

11. A computer-readable medium for characterizing the performance over a network to a request for information, comprising logic instructions that, when executed:
(a) intercept a request for information;
(b) forward said request to a server to which said request was addressed;
(c) intercept a response from said server;
(d) add a performance-measuring logic code to said response;
(e) forward said response to said user's browser;
(f) receive confirmation from said browser of execution of said request;
(g) determine, as a performance metric, the elapsed time between said interception of said request and said receipt of confirmation, by using timing information received from execution of said logic code at said browser.

12. The computer-readable medium of claim 11 further comprising
(i) logic instructions that, when executed, log a time at which said request was intercepted, and
(ii) logic instructions that, when executed, log a time at which said confirmation was received;
and where
(iii) said elapsed time in said (g) is the difference between said times logged in said (i) and (ii).

13. A proxy server for characterizing the performance over a network to a request for information, comprising:
(a) means for intercepting a request for information;
(b) means for forwarding said request to a server to which said request was addressed;
(c) means for intercepting a response from said server;
(d) means for adding a performance-measuring logic code to said response;
(e) means for forwarding said response to said user's browser;
(f) means for receiving confirmation from said browser of execution of said request;
(g) means for determining, as a performance metric, the elapsed time between said interception of said request and said receipt of confirmation.

14. The proxy server of claim 13 further comprising
(i) means for logging a time at which said request was intercepted, and
(ii) means for logging a time at which said confirmation was received;
and where
(iii) said elapsed time in said (g) is the difference between said times in said times logged in said (i) and (ii).

15. The proxy server of claim 13 further comprising means for computing an additional performance metric based on the loading of a portion of said response at said browser.

16. A method for modifying a document, intercepted by a proxy server en route from a content server to a browser, to enable said browser to report a time of completion of loading and rendering said document as said browser, comprising:
(a) intercepting, at a proxy server, a document en route from a content server to a browser;
(b) inserting into said document a browser-executable logic code for determining at least one time associated with loading a portion of said document at said browser; and
(c) said logic code being configured to send a report including said time back to said proxy server upon completion of rendering said document.

17. The method of claim 16 where said report comprises a URL in which said time is embedded as a textual string.

18. The method of claim 16 where said time represents the initiation of loading of said document at said browser.

19. The method of claim 16 where said time represents the completion of loading of HTML portions of said document at said browser.

20. The method of claim 16 where said time represents the completion of rendering of all of said document at said browser.
